(19) United States
(12) Patent Application Publication
(10) Pub. No.: US 2006/0153959 A1
(43) Pub. Date: Jul. 13, 2006

(54) Flavour compositions

(76) Inventors: John Martin Behan, Ashford (GB); David Jonathan Bradshaw, Ashford (GB); Jonathan Richards, Kent (GB); Michael John Munroe, Ashford (GB)

Correspondence Address: MORGAN LEWIS & BOCKIUS LLP, 1111 PENNSYLVANIA AVENUE NW, WASHINGTON, DC, 20004, US

(21) Appl. No.: 10/545,888

(22) PCT Filed: Feb. 11, 2004
(86) PCT No.: PCT/GB04/00520

§ 371 Date: Aug. 17, 2005

(30) Foreign Application Priority Data
Feb. 18, 2003 (GB) 0303678.7

(51) Int. Cl. A23L 1/22

(52) U.S. Cl. 426/534

(57) ABSTRACT

A flavour composition comprises at least 0.5% by weight of one or more of the following group A materials: cinnamic aldehyde, basil oil, tarragon, cis-3-hexenyl acetate, cis-3hexenol, orange oil, lime, citral, and damascone; and at least 3% by weight of one or more of the following group B materials: anethole synthetic, alcohol C10, eucalyptol, methyl salicylate, clove bud oil, carvone laevo, benzyl benzoate, thymol, benzaldehyde, benzyl formate, ethyl salicylate, eucalyptus oil, ionone alpha, iso amyl acetate, rosemary oil, cardamom oil, ginger, eugenol, camomile oil, spearmint, and peppermint. These materials have been identified as being capable of inhibiting the growth of Porphyromonas gingivalis or the protease (arg-gingipain) activity of Porphyromonas gingivalis, and so to possess hitherto unappreciated antimicrobial properties. The invention thus enables compositions to be defined comprising flavour materials that enhance the antimicrobial efficacy of known antimicrobial agents against micro-organisms or metabolic processes associated with gum diseases. The invention also provides a consumer product, particularly an oral or dental care product, including such a flavour composition; a method for reducing or preventing gum disease; and use of the flavour compositions for reducing or preventing gum disease.

### FIELD OF THE INVENTION

This invention relates to flavour compositions, i.e. a mixture of flavour materials, to products, particularly oral and dental care products, containing such flavour compositions, and to the use of flavour materials or a flavour composition to deliver a beneficial effect on gum health.

### BACKGROUND TO THE INVENTION

Bacteria present in the oral cavity, particularly bacteria commonly found in large numbers in dental plaque which can accumulate on the surface of the teeth, are typically responsible for two of the most common diseases affecting humans in the developed world: dental caries (or tooth decay) and gum diseases such as gingivitis and/or periodontitis.

Dental caries is caused by bacteria including Streptococcus mutans present in plaque. The bacteria ferment dietary sugars and carbohydrates to form lactic acid which dissolves the hydroxyapatite of the tooth enamel and dentine.

Plaque that forms on a tooth just above the margin of the gum (the gingival margin) can accumulate bacteria, bacterial products and enzymes. This marginal plaque can grow down into the gingival crevice and induce a change of flora, which may lead to inflammation, bleeding, tenderness and redness of the tissues surrounding the tooth (gingivitis). Periodontitis is a more advanced stage of gum disease involving bone and ligament surrounding a tooth, and is the leading cause of tooth loss amongst adults. Specific groups of bacteria, especially Porphyromonas gingivalis, and particular enzymes, especially proteases, particularly arg-gingipain, are implicated in the damage caused to periodontal tissues.

Accumulated plaque can be removed mechanically by a dental professional. However, the incorporation of agents in oral care products, particularly toothpaste, has been proposed for many years as a possible valuable adjunct to mechanical plaque control.

There appear to be many agents with relevant properties for use as plaque control agents. Antimicrobial agents currently used in oral care products include chlorhexidine, cetylpyridinium chloride etc. Although many have been tried in various oral care products, relatively few have been found to be suitable, especially in toothpaste formulations, either because of a lack of compatibility or because of a lack of clinical efficacy. For example, although chlorhexidine is an extremely effective antimicrobial agent, it interacts with foaming and abrasive agents used in most dentrifices resulting in reduced bioavailability. Further, some agents are inactivated when adsorbed to a surface or when bound to host proteins, whereas the oral cavity provides unfavourable pharmacokinetics for other agents.

A number of oral care products in recent years have been developed based on triclosan (2′,4,4′-trichloro-2-hydroxy-diphenyl ether), a broad spectrum antimicrobial agent. Triclosan has also been combined with other molecules in an attempt to boost its clinical efficacy. The combination of triclosan with Gantrez copolymer (polyvinyl methyl ether maleic acid) (where Gantrez is a Trade Mark) has been shown to increase the retention of triclosan to surfaces, and to raise its anti-plaque and antimicrobial activity in a range of laboratory tests. Other studies have found greater inhibitory effects on bacterial viability when triclosan is combined with either pyrophosphate or zinc citrate. Both of these combinations were shown to selectively inhibit those bacterial species implicated in gingivitis and advanced periodontal diseases. More recently, zinc has been used alone as an active agent.

It is common practice to incorporate flavour materials in various oral care products, such as toothpaste, mouth rinse, chewing gum etc., for aesthetic reasons. It is also known that certain flavour materials have antimicrobial properties, that is, as well as having pleasant taste characteristics the materials are also effective at killing or inhibiting at least certain micro-organisms such as bacteria, fingi, yeasts, viruses.

### SUMMARY OF THE INVENTION

The present invention is based on extensive testing of flavour materials to determine whether a particular component is capable of inhibiting the growth of Porphyromonas gingivalis or the protease (arg-gingipain) activity of Porphyromonas gingivalis. Based on this testing, flavour materials have been identified, which whilst known, may possess hitherto unappreciated antimicrobial properties. The invention thus enables compositions to be defined comprising flavour materials that synergise with known antimicrobial agents against micro-organisms or metabolic processes associated with gum diseases.

Accordingly, in one aspect, the present invention provides a flavour composition comprising at least 0.5% by weight of one or more of the following group A materials: cinnamic aldehyde, basil oil, tarragon, cis-3-hexenyl acetate, cis-3-hexenol, orange oil, lime, citral, and damascone; and at least 3% by weight of one or more of the following group B materials: anethole synthetic, alcohol C10, eucalyptol, methyl salicylate, clove bud oil, carvone laevo, benzyl benzoate, thymol, benzaldehyde, benzyl formate, ethyl salicylate, eucalyptus oil, ionone alpha, iso amyl acetate, rosemary oil, cardamom oil, ginger, eugenol, camomile oil, spearmint, and peppermint.

The ingredients of the composition are known flavour materials which are readily available commercially in grades suitable for various intended purposes. Details of the flavour materials and potential suppliers thereof are mentioned, for example, in “Allured's Flavor and Fragrance Materials 2002”, Allured Publishing Corp., Carol Stream, Illinois, USA, ISBN 0-931710-84-7.

The cinnamic aldehyde is conveniently cinnamic aldehyde extra, available from Quest International.

The basil oil is conveniently basil comores.

The orange oil is conveniently orange Florida.

The clove bud oil is preferably rectified, e.g. clove bud rectified extra.

The eucalyptus oil is conveniently eucalyptus globulus.

The rosemary oil is conveniently rosemary Spanish.

The cardamom oil is conveniently cardamom English.

The camomile oil is conveniently camomile English.

The spearmint is preferably a spearmint oil and is preferably of natural origin. The spearmint preferably comprises more than 60% by weight carvone laevo, more preferably more than 76% by weight carvone laevo. The spearmint preferably contains less than 4% by weight limonene. Preferred spearmint materials include Spearmint American Far West Native Deep Cut. A mixture of spearmint materials may be used.

The peppermint is preferably a peppermint oil and is preferably of natural origin. The peppermint preferably contains cineole at less than 0.7% by weight. The peppermint preferably contains iso menthane in an amount of greater than 7.7% by weight. Preferred peppermint materials include Peppermint Indian, Peppermint Chinese, Peppermint American (e.g. Peppermint American Native Deep Cut M&W), and Peppermint Aspen. A mixture of peppermint materials may be used.

The composition preferably includes at least 5% by weight, more preferably at least 10% by weight, yet more preferably at least 15% by weight of one or more materials from group A.

The composition preferably includes at least 5% by weight, more preferably at least 10% by weight, yet more preferably at least 15% by weight of one or more materials from group B.

The composition preferably includes at least two materials from group A.

The composition preferably includes at least two materials from group B.

Also included within the scope of the invention is a method, particularly a cosmetic method, for reducing or preventing gum disease by introducing in the oral cavity a flavour composition in accordance with the invention.

The flavour materials useful in a flavour composition of the invention are capable of contributing to the reduction or prevention of gum disease by inhibiting growth of Porphyromonas gingivalis and/or by inhibiting the protease (arg-gingipain) activity of Porphyromas gingivalis.

One property that characterises the effectiveness of a compound e.g. a flavour material, to inhibit the growth or activity of a particular micro-organism in the oral cavity is the minimum inhibitory concentration, or MIC, of the compound. The MIC is the minimum amount of a compound (e.g. in ppm) at which no bacterial growth is observed. Generally, the lower the MIC of a compound for a bacterium, the more effective the compound will be at inhibiting bacterial growth. At concentrations above the MIC, a compound may act by directly killing existing viable bacteria or inhibiting the growth and reproduction of the bacteria (antimicrobial effect). At concentrations below the MIC, a compound may interfere with the metabolic process, e.g. by reducing the activity of bacterial enzymes, but typically does not inhibit the growth and reproduction of bacteria (sub-lethal or sub-MIC effect).

The inhibitory effect of a flavour composition comprising the flavour materials useful herein can be achieved antimicrobially, or more surprisingly, sub-lethally.

The antimicrobial effects of compounds, e.g. flavour materials, are usually divided into two types; they can either inhibit bacterial growth (bacteriostatic action) or alternatively they can act by directly killing existing viable bacteria (bactericidal action).

The bacteriostatic action of a compound “X” (such as a flavour material) against a particular bacterium, can be tested for in vitro by inoculating a standard, small number of bacteria into broths containing an appropriate range of concentrations of X. The broths are then incubated for a suitable time, and growth compared with a control containing no inhibitor. The broth containing the lowest concentration of X which shows reduction of growth compared to the control broth, is defined as the minimum inhibitory concentration (MIC).

The determination of the bactericidal action of a compound “Y” (such as a flavour material) is carried out by adding various concentrations of compound Y to replicate broths containing relatively high, standard numbers of bacteria. After a certain period allowing any antibacterial activity to take place, aliquots of the bacterial cultures are diluted (usually in 10-fold steps) and dispensed onto agar plates. The plates are incubated with the expectation that each viable cell should produce a visible colony. The numbers of colonies are multiplied to take account of the dilution, to establish the number of viable cells in the broths. Once again, the broths containing compound Y are compared with an untreated control broth. The minimum concentration of compound Y which causes a reduction in the viable number of bacteria is the minimum bactericidal concentration (MBC). MBC can also be expressed in terms of the MBC required to produce a certain degree of killing (for example, a 3 log₁₀ reduction in count, equivalent to a 99.9% kill). Still further, the MBC can be expressed in kinetic terms—the time of exposure to an agent required for a given MBC effect.

A further possibility is that the process of inhibition could be sub-lethal (or sub-MIC), whereby the flavour materials interfere with the metabolic process, but typically do not inhibit bacterial growth.

As described herein above, typically, the lower the MIC value of a material, the more effective the material is at inhibiting bacterial growth.

Three modes of achieving the reduction in gum disease are possible. In the first mode, the flavour materials (or flavour compositions) may act by direct (overt antimicrobial) killing of oral cavity bacteria, e.g. by more than 10-fold; in the second mode, they may act on protease (arg-gingipain) generation whilst maintaining a microbial cell viability of at least 70%; in the third mode, they may inhibit protease (arg-gingipain) generation, at a concentration below the minimum inhibitory concentration (MIC) (which can be determined in known manner). The third mode is preferred, since this provides gum health benefits, whilst leaving the natural oral cavity microflora undisturbed. Thus, preferably, the bacterial production of protease (arg-gingipain) can be reduced or eliminated without significantly disturbing the oral cavity's natural microflora. This may be achieved by inhibiting the bacteria responsible for the production of protease (arg-gingipain), in particular Porphyromonas gingivalis at a concentration below the MIC.

In an even further aspect the present invention provides use of a flavour composition in accordance with the invention, for the purpose of reducing and/or preventing gum disease.

The flavour composition typically also includes other flavour ingredients (which may be selected from the 400-500 or so flavour materials that are in current use when formulating flavour compositions) chosen to give desired overall flavour characteristics to the composition.

The ingredients of the composition are known flavour materials which are readily available commercially in grades suitable for various intended purposes.

The flavour composition of the invention can be readily made by simply mixing the specified ingredients, as is well known to those skilled in the art.

The flavour compositions of the invention find application in a wide range of consumer products, particularly oral care products such as toothpastes, mouthwashes, chewing gum (where the term “chewing gum” is intended also to encompass bubble gum), dental floss, dissolvable mouth films, breath sprays and breath freshening tablets.

The present invention also includes within its scope consumer products, particularly oral or dental care products, including a flavour composition in accordance with the invention.

The consumer products, particularly oral and dental care products, which include a flavour composition in accordance with the invention may be formulated in a conventional manner as is well known to those skilled in the art. For example, a toothpaste formulation will typically include 0.3% to 2%, preferably from 0.5% to 1.5%, more preferably from 0.8% to 1.2% by weight, of the flavour composition. A mouthwash will typically contain the flavour composition in an amount in the range 0.05% to 2%, preferably from 0.1% to 1%, more preferably from 0.15% to 0.5% by weight. For a chewing gum, the composition of the invention may be present in an amount in the range 0.5% to 3.5%, preferably from 0.75% to 2%, more preferably from 1% to 1.75% by weight.

The consumer product conveniently also includes known antimicrobial materials such as triclosan, zinc salts etc. These can be present in lower amounts than is conventional.

The invention will be further illustrated by the following Examples.

### EXAMPLE 1

### Arg-Gingipain Protease Enzyme Assay

The following assay was used to investigate the inhibition of protease activity of the micro-organism Porphyromonas gingivalis (implicated in gum disease) by a flavour material or mixture of flavour materials.

Enzyme Buffer

Fresh buffer was prepared immediately before beginning the assay in the following manner: 3.029 g of Tris Base (Sigma, Poole, UK), 394 mg of L-cysteine hydrochloride (Sigma, Poole, UK) and 367.5 mg of calcium chloride dihydrate (Sigma, Poole, UK) were dissolved in 150 ml deionised water. In order to allow for pH differences resulting from any variation in ambient temperature, the temperature of the buffer was taken. The pH of TRIS buffers varies with temperature, Δ pH=−0.031/° C. This assay should be carried out at a temperature of 30° C., with the buffer having a pH of 8.0. Thus, if the measured temperature of the buffer is, for example, 22° C. (room temperature) the pH should be adjusted to 8.24 with 2M hydrochloric acid, in order to give the desired conditions i.e. pH=8.0 at 30° C. After adjusting the pH, the buffer was made up to 200 ml with deionised water and incubated in a water bath at 30° C. for approximately one hour to reach temperature equilibrium before commencing the assay.

Enzyme Substrate (BAPNA) Solution

The enzyme substrate BAPNA (DL-α-benzoyl-DL-arginyl-p-nitro-anilide) (Sigma) is degraded by enzymes which show specificity for cleaving adjacent to arginine residues. This cleavage yields a yellow coloured product (nitroaniline), in proportion to the enzyme activity, that is readily detectable. 10.87 mg of the BAPNA substrate was added to 0.5 ml of dimethylsulphoxide (DMSO) and thoroughly dissolved. 9.5 ml of deionised water was then added. The resulting solution was then mixed by vortex and incubated at 30° C. in a water bath for about one hour before commencing the assay to allow temperature equilibration.

Bacterial Culture

Porphyromonas gingivalis W50 ATCC 53978 (American Type Culture Collection (ATCC), P.O. Box 1549, Manassas, Va. 20108, USA) (may also be obtained from Prof. Philip Marsh, Centre for Applied Microbiology and Research, Salisbury, Wiltshire, SP4 OJG, UK) was sub-cultured from frozen stock cultures onto Schaedler Anaerobic Agar (Oxoid, Basingstoke, UK), and supplemented with 5% v/v horse blood (E&O Laboratories, Bonnybridge, Scotland, FK4 2HH). The plates were incubated at 37° C. in an anaerobic cabinet (Don Whitley Scientific, Shipley, UK) for 3-5 days. Single colonies grown on these plates were then inoculated into 250 ml of Schaedler Anaerobic Broth (SAB) contained in bottles with cotton wool stoppers. The broths were then incubated in an anaerobic cabinet and allowed to grow for 3-5 days. This generally yielded a culture with an optical density at 540 nm between 0.2 and 0.4.

Assay Procedure

Into 1.5 ml disposable plastic cuvettes was added 0.7 ml of assay buffer followed by 0.2 ml BAPNA solution, and 0.1 ml of bacterial culture. Immediately, the absorbance at 405 nm (A₄₀₅) was measured and used to zero the spectrophotometer (a Pye Unicam 8620 Spectrophotometer (Pye Unicam, Cambridge, UK)). The cuvette is then placed into a 37° C. water bath, and read after 3 minutes incubation. The increase in A₄₀₅ₙₘ is a measure of the arg-gingipain enzyme of the bacterial culture.

In order to measure the inhibition of enzyme activity by a flavour material or a mixture of flavour materials, the procedure was repeated in the presence of a material or mixture to be tested and the effect on absorbance at A₄₀₅ measured. In practice, this was achieved by making flavour material stock solutions to ten-fold greater concentration than the final desired concentration in assay buffer. 0.1 ml of the stock solution was then added to 0.6 ml of assay buffer, 0.2 ml BAPNA solution and 0.1 ml of bacterial culture.

### EXAMPLE 2

### Minimum Inhibitory Concentration (MIC)

The minimum inhibitory concentration of a flavour material or flavour composition (flavour) was determined by the following method.

A culture of the test strain Porphyromonas gingivalis W50 ATCC 53978 (American Type Culture Collection (ATCC), P.O. Box 1549, Manassas, Va. 20108, USA) (may also be obtained from Prof. Philip Marsh, Centre for Applied Microbiology and Research, Salisbury, Wiltshire, SP4 0JG, UK) was grown in 250 ml of Schaedler Anaerobic Broth (SAB) (Oxoid, Basingstoke, UK), anaerobically at 37° C. for 3-4 days. The absorbance of the culture at 540 nm (A₅₄₀) was measured and adjusted to 0.2-0.3 by diluting with fresh SAB broth. The culture was then diluted in SAB in a ratio of 1 part culture to 25 parts broth to give a stock inoculum culture.

Flavour or flavour materials were diluted in sterile SAB to yield a 10,000 ppm stock solution, and the mixture vigorously mixed by vortex. Each row of a standard, 96-well plastic microtitre plate (labelled A-G) was allocated to one flavour/flavour material sample, thus seven samples per plate. Row H contained only SAB broth for use as a bacterial control to indicate the degree of turbidity resulting from bacterial growth in the absence of any test material. Aseptically, 200 μl of the initial dilution of flavour/flavour material was transferred to the 1^{st} and 7^{th} well of the appropriate row. All other test wells were filled with 100 μl of sterile SAB using an 8-channel micro-pipette. The contents of each of the wells in column 1 were mixed by sucking samples up and down in pipette tips, before 100 μl was transferred to column 2. The same sterile pipette tips were used to transfer 100 μl of each well in column 7, into the appropriate well in column 8. This set of eight tips was then discarded into disinfectant solution. Using eight fresh sterile tips the process was repeated by transferring 100 μl from column 2 into column 3 (and 8 into 9). The process was continued until all wells in columns 6 and 12 contained 200 μl. After mixing, 100 μl was discarded from each of the wells in columns 6 and 12 to waste. Finally, 100 μl of the pre-diluted stock inoculum culture was added to all wells (except the control, no bacteria wells in row H), thus giving a final volume of 200 μl in each well.

A blank plate was prepared for each set of seven samples by repeating the process described above, except that 100 μl of SAB was added instead of bacterial culture. This plate was used as the control plate against which the test plate(s) could be read.

Test and control plates were sealed using autoclave tape and incubated for 48 hours anaerobically at 37° C.

A microtitre plate reader (Model MRX, Dynatech Laboratories) was preset to gently agitate the plates and mix the contents. The absorbance at 540 nm “A₅₄₀” was used as a measure of turbidity resulting from bacterial growth. The control, un-inoculated plate for each set of samples was read first, and the plate reader then programmed to use the control readings to blank all other plate readings for the inoculated plates for the same set of test materials (i.e. removing turbidity due to flavour and possible colour changes during incubation). Thus, the corrected readings generated were absorbances resulting from turbidity from bacterial growth. The MIC was taken as the concentration of flavour/flavour material required to inhibit growth so that the change in absorbance during the incubation period was <0.2 A₅₄₀.

### EXAMPLE 3

### Flavour Composition

A flavour composition in accordance with the invention was prepared by mixing the following ingredients.

| | % | Group |
|---|---|---|
| Aniseed Rectified | 8.80 | |
| Basil Comores | 1.00 | A |
| Cis-3-Hexenol | 1.00 | A |
| Lime Oil | 6.00 | A |
| Menthol Laevo | 32.00 | |
| Orange Oil | 11.00 | A |
| Peppermint Chinese | 23.50 | B |
| Peppermint Aspen | 15.70 | B |
| Tarragon Oil | 1.00 | A |
| Total Quantity | 100 | 20% A; 39.2% B |

### EXAMPLE 4

### Flavour Composition

A flavour composition in accordance with the invention was prepared by mixing the following ingredients.

| | % | Group |
|---|---|---|
| Aniseed Rectified | 9.35 | |
| Basil Oil | 0.30 | A |
| Carvone Laevo | 3.00 | B |
| Eucalyptol | 3.75 | B |
| Eugenol | 2.10 | B |
| Ginger Oil | 0.15 | B |
| Menthol Laevo | 33.40 | |
| Peppermint Aspen | 27.75 | B |
| Peppermint Indian | 13.90 | B |
| Rosemary Spanish Oil | 0.75 | B |
| Spearmint American Far West | 5.25 | B |
| Native Deep Cut W&M | | |
| Tarragon | 0.30 | A |
| Total Quantity | 100 | 0.6% A; 56.65% B |

### EXAMPLE 5

### Formulations

Either of the flavour compositions described in Examples 3 and 4 above may be included in the following toothpaste, mouthwash, or chewing gum formulations, which are prepared according to conventional methods known to those skilled in the art:

Chalk Toothpaste

| Material | % w/w |
|---|---|
| Glycerine | 20.0 |
| Distilled Water | 35.3 |
| Calcium Carbonate (Sturcal H) | 40.0 |
| Sodium Carrageenate (Viscarin) | 2.00 |
| Sodium Saccharin | 0.20 |
| Sodium Lauryl Sulphate (Empicol LZPV/C) | 1.50 |
| Flavour Composition | 1.00 |
| Total | 100.00 |

where Sturcal H, Viscarin and Empicol LZPV/C are all Trade Marks.

Opacified Silica Toothpaste

| Material | % w/w |
|---|---|
| Sorbitol 70% syrup | 50.0 |
| Distilled Water | 23.6 |
| Sodium Monofluorophosphate | 0.80 |
| Trisodium Phosphate 12H₂O | 0.10 |
| Sodium Saccharin | 0.20 |
| Precipitated Silica (AC 30) | 8.00 |
| Precipitated Silica (TC 15) | 8.00 |
| Sodium Carboxy Methyl Cellulose (9M31XF) | 0.80 |
| Titanium Dioxide (Tiona) | 1.00 |
| Sodium Lauryl Sulphate (Empicol LZPV/C) | 1.50 |
| Polyethylene Glycol 1500 | 5.00 |
| Flavour Composition | 1.00 |
| Total | 100.00 |

Where Tiona and Empicol LZPV/C are Trade Marks.
Ready-To-Use Mouthwash

Mixture A—Alcohol Phase

| | % w/w |
|---|---|
| Ethanol 96%, Double Rectified | 12.000 |
| PEG 40 Hydrogenated Castor Oil (Cremophor RH40) | 0.250 |
| Flavour Composition | 0.200 |

Mixture B—Aqueous Phase

| | % w/w |
|---|---|
| Sorbitol 70% syrup | 12.000 |
| Saccharin 25% solution | 0.200 |
| Cetyl Pyridinium Chloride | 0.025 |
| Distilled Water | 75.325 |

Where Cremophor RH40 is a Trade Mark.

The alcohol phase (mixture A) and aqueous phase (mixture B) were prepared separately and then combined to give the mouthwash.

Chewing Gum

| Material | % w/w |
|---|---|
| Gum Base Balear T | 28.0 |
| Sorbitol Powder | 52.9 |
| Sorbitol Syrup | 6.0 |
| Xylitol | 6.0 |
| Glycerol 98% | 5.0 |
| Aspartame | 0.05 |
| Acesulfame K | 0.05 |
| Flavour Composition | 2.0 |

where Balear T and Acesulfame K are Trade Marks.

1. A flavour composition comprising at least 0.5% by weight of one or more of the following group A materials: cinnamic aldehyde, basil oil, tarragon, cis-3-hexenyl acetate, cis-3-hexenol, orange oil, lime, citral, and damascone; and at least 3% by weight of one or more of the following group B materials: anethole synthetic, alcohol C10, eucalyptol, methyl salicylate, clove bud oil, carvone laevo, benzyl benzoate, thymol, benzaldehyde, benzyl formate, ethyl salicylate, eucalyptus oil, ionone alpha, iso amyl acetate, rosemary oil, cardamom oil, ginger, eugenol, camomile oil, spearmint, and peppermint.

2. A composition according to claim 1, wherein the spearmint is of natural origin and preferably comprises more than 60% by weight carvone laevo, more preferably more than 76% by weight carvone laevo.

3. A composition according to claim 1, wherein the spearmint is of natural origin and preferably contains less than 4% by weight limonene.

4. A composition according to claim 3, wherein the spearmint is Spearmint American Far West Native Deep Cut.

5. A composition according to claim 1, wherein the peppermint is of natural origin and preferably contains cineole at less than 0.7% by weight.

6. A composition according to claim 5, wherein the peppermint is of natural origin and preferably contains iso menthane in an amount of greater than 7.7% by weight.

7. A composition according to claim 6. wherein the peppermint is selected from one or more of the following: Peppermint Indian, Peppermint Chinese, Peppermint American and Peppermint Aspen.

7. (canceled)

8. A composition according to claim 1, wherein the composition includes at least 5% by weight, more preferably at least 10% by weight, yet more preferably at least 15% by weight of one or more materials from group A.

9. A composition according to claim 8, wherein the composition includes at least 5% by weight, more preferably at least 10% by weight, yet more preferably at least 15% by weight of one or more materials from group B.

10. A composition according to claim 9, wherein the composition includes at least two materials from group A.

11. A composition according to claim 10, wherein the composition includes at least two materials from group B.

12. A consumer product, particularly an oral or dental care product, including a flavour composition in accordance with claim 1.

13. A method, particularly a cosmetic method, for reducing or preventing gum disease by introducing in the oral cavity a flavour composition or consumer product in accordance with claim 1.

14. (canceled)
